(19) United States
(12) Patent Application Publication
(10) Pub. No.: US 2025/0024857 A1
(43) Pub. Date: Jan. 23, 2025

(54) METHOD FOR PRODUCING A SEAFOOD IMITATION PRODUCT

(71) Applicant: FUKUICHI FISHERY CO., LTD, Yaizu-Shi (JP)

(72) Inventors: Taichiro Kondo, Yaizu-Shi (JP); Daisuke Kondo, Yaizu-Shi (JP); Hiroshi Kondo, Yaizu-Shi (JP); Akito Kobayashi, Yaizu-Shi (JP)

(21) Appl. No.: 18/777,209

(22) Filed: Jul. 18, 2024

(30) Foreign Application Priority Data
Jul. 18, 2023 (JP) 2023-116435

(51) Int. Cl. A23J 3/22; A23L 17/00; A23L 33/21

(52) U.S. Cl. CPC A23J 3/227; A23L 17/70; A23L 33/21

(57) ABSTRACT

The object of the present invention is to provide a method for producing the reproducible seafood imitating product which can reproduce the flesh of the seafood better than before.

A method for producing the seafood imitating product of the present invention is provided. This production method is a method for producing the seafood imitating product including dietary fiber comprising mixing dietary fiber and the first thickener in water to prepare a flesh solution, forming a layer of the flesh solution, preparing a tendon solution which includes titanium dioxide and/or calcium carbonate and the second thickener and has different viscosity from the flesh solution, forming a layer of the tendon solution on the layer of the flesh solution, inserting a blade from the above of the layer of the tendon solution and making a cut by the blade into the layer of the flesh solution through the layer of the tendon solution, pulling up the blade and putting the tendon solution into the cut of the layer of the flesh solution, and solidifying the flesh solution and the tendon solution.

This application claims priority to Japanese Patent Application No. 2023-116435, filed on Jul. 18, 2023, which is hereby incorporated by reference in its entirety.

### TECHNICAL FIELD

The present invention relates to a method for producing a seafood imitating product.

### BACKGROUND ART

There are various principles and ideas also in the meal in the present days when the human diversity has been called for loudly. For example, vegetarians who do not take meat, and the like exist, although they are generally called vegetarians, not only vegetarians who take egg or milk, and the like, but also total vegetarians (so-called Vegans) who abstain from all food of animal origin exist.

Even if they are Vegans, they sometimes want to take the food except vegetables, and the like. In order to satisfy such a desire, for example, as described in patent document 1, the imitation food which imitates the food derived from animals but does not use materials derived from animals is developed.

### CITATION LIST

### Patent Literature

[PTL 1]
Japanese unexamined patent publication No. 2021-159076

### SUMMARY OF INVENTION

### Technical Problem

A lot of imitation food is developed. However, the seafood imitating product imitating seafood, and the like cannot reproduce a tendon peculiar to seafood enough so far. Therefore, the conventional seafood imitating product did not satisfy a visual desire of a person who eats them. Also, although it was attempted that a tendon was incorporated between the flesh to reproduce the tendon, it was easy to come off between the tendon and the flesh of the generated imitation food and the quality was insufficient to circulate.

The present invention is intended to provide a method for producing a seafood imitating product which can reproduce flesh of seafood reproducibly than before and the tendon and the flesh are hard to come off.

### Solution to Problem

The inventors of the present invention found that the seafood imitating product with tendon just like real seafood could be produced, by forming a layer of tendon solution with different viscosity from the flesh solution on a layer of the flesh solution, making a cut in the layer of the flesh solution by a blade through the layer of the tendon solution, and putting the tendon solution into the cut by pulling up the blade, and the present invention was completed.

Therefore, the present invention provides a method for producing a seafood imitating product including dietary fiber, comprising:
mixing dietary fiber and the first thickener in water to prepare a flesh solution; forming a layer of the flesh solution;
preparing a tendon solution which includes titanium dioxide and/or calcium carbonate and the second thickener and has different viscosity from the flesh solution;
forming a layer of the tendon solution on the layer of the flesh solution;
inserting a blade from the above of the layer of the tendon solution, and making a cut in the layer of the flesh solution by the blade through the layer of the tendon solution;
pulling up the blade and putting the tendon solution into the cut of the layer of the flesh solution; and
solidifying the flesh solution and the tendon solution.

Also, the present invention provides the method for producing the seafood imitating product described above which the flesh solution is prepared by further mixing with tapioca powder and/or lycopene.

Also, the present invention provides the method for producing the seafood imitating product described above which further comprises freezing the solidified body after solidifying the flesh solution and the tendon solution.

Also, the present invention provides the method for producing the seafood imitating product described above which the flesh solution is prepared by further mixing with vegetable ingredient(s).

### Advantageous Effects of Invention

By forming a layer of the tendon solution with different viscosity from the flesh solution, and making a cut in a layer of the flesh solution through the layer of this tendon solution by a blade, and putting the tendon solution into the cut by pulling up the blade, the seafood imitating product with the tendon just like real seafood can be produced. Besides, color, cloudiness and mouthfeel of the red flesh of tuna can also be reproduced by adding tapioca and lycopene to the flesh solution, and freezing after solidifying the flesh solution.

### BRIEF DESCRIPTION OF DRAWINGS

FIG. 1 is a flow diagram of an example of the method for producing the seafood imitating product concerning the embodiment.

FIG. 2 is a schematic diagram indicating a step of making a cut in an example of the method for producing the seafood imitating product concerning the embodiment.

FIG. 3 is a schematic cross-sectional view of the seafood imitating product which can be obtained in an example of the method for producing the seafood imitating product concerning the embodiment.

FIG. 4 is a flow diagram of an additional example of the method for producing the seafood imitating product concerning the embodiment.

### DESCRIPTION OF EMBODIMENTS

Some examples of the method for producing the seafood imitating product concerning the embodiment are described below, referring to the drawings. However, the method for producing the seafood imitating product of the present invention is not limited to the examples described below.

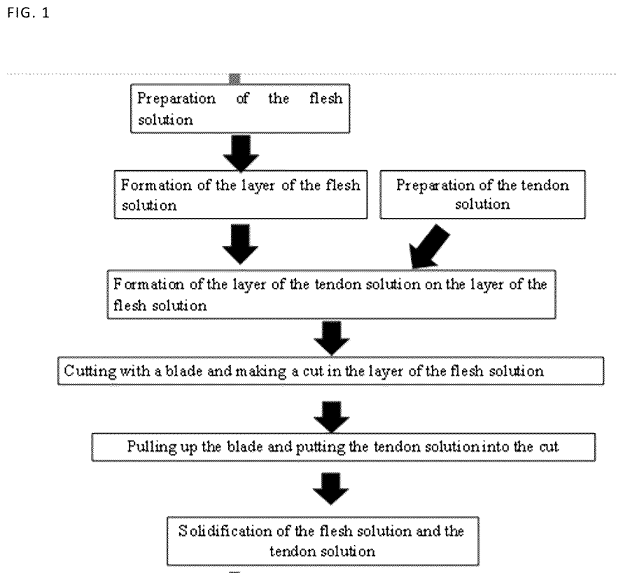

At first, referring to FIG. 1-FIG. 3, an example of the method for producing the seafood imitating product concerning the present invention is described. The seafood imitating product of the present invention is produced by preparing the flesh solution and the tendon solution, respectively, and putting the tendon solution into the flesh solution.

### <Preparation of the Flesh Solution>

At first, a mixture is obtained by mixing dietary fiber and the first thickener in water. This mixture is referred to as flesh solution. As used herein, the solution obtained by mixing at least dietary fiber and the first thickener in water is referred to as flesh solution. The flesh solution is the material that forms the part imitating fish flash. The word “fish flash” includes fish meat.

For example, dietary fiber can be water-soluble dietary fiber. Herein, the water-soluble dietary fiber is dietary fiber dissolving in a water solution, and includes dietary fiber having a property to increase the viscosity of the water solution by dissolving in a water solution. The water-soluble dietary fiber as used herein can be, but is not particularly limited to, for example, glucomannan (e.g., konjac potato), dietary fiber derived from seaweed (e.g., agar) and a chemically modified polysaccharide (e.g., modified starch), and the like. Glucomannan is a polysaccharide existing in konjac potato. Glucomannan can be obtained as konjac powder, for example, by drying and crushing a konjac potato and separating impurities. Konjac powder includes about 75-85% by mass of glucomannan. A commercial product can be used for Glucomannan.

The quantity of dietary fiber can be adjusted so that desired hardness and viscosity are obtained in the seafood imitating product, and can be, for example, per 100 parts by mass of the flesh solution, 0.3 parts by mass or more to 10 parts by mass or less of the quantity, and it is preferable to be 0.5 parts by mass or more to 7 parts by mass or less of the quantity.

The first thickener is not limited, as long as it is a thickener for food. The thickener can be, for example, methylcellulose, locust bean gum, guar gum, gellan gum, carboxymethylcellulose, arabic gum, xanthan gum, cornstarch, carrageenan and pectin. The quantity of the thickener can be adjusted so that desired hardness and viscosity are obtained in the seafood imitating product, and can be, for example, per 100 parts by mass of the flesh solution, 0.3 parts by mass or more to 5 parts by mass or less of the quantity, and it is preferable to be 0.5 parts by mass or more to 3 parts by mass or less of the quantity.

At the time of the preparation of the flesh solution, tapioca powder can be added. The tapioca powder is powder of starch produced from the rhizome of cassava. The tapioca powder can not only reproduce white of seafood by being contained in the seafood imitating product, but can also reproduce the color of the flesh of seafood by being used together with other colorant(s). The seafood imitating product containing the tapioca powder of the present invention can produce white color by freezing after solidification.

The quantity of the tapioca powder can be adjusted so that desired whiteness, hardness and viscosity are obtained in the seafood imitating product, and can be, for example, per 100 parts by mass of the flesh solution, 1 part by mass or more to 10 parts by mass or less of the quantity, and it is preferable to be 2 parts by mass or more to 8 parts by mass or less of the quantity. Also, the tapioca powder may be provided as a solution by mixing the powder in the solvent such as water and the tapioca powder may also be provided as a solution by heating and dissolving it in a solvent.

Also, at the time of the preparation of the flesh solution, other colorant(s) can be added in addition to the tapioca powder. The other colorant(s) can be a colorant developing a desired color, and includes, but is not limited to, for example, lycopene pigment and paprika pigment.

When adding lycopene pigment, the feel of the red flesh of tuna can be finally reproduced. The feel of the red flesh of tuna can be finally reproduced. Lycopene pigment can be added with, per 100 parts by mass of the flesh solution, 0.01 parts by mass or more to 3.0 parts by mass or less, for example, 0.05 parts by mass or more to 0.5 parts by mass or less of the quantity. By containing lycopene pigment with such a quantity, the color and texture of the red flesh of tuna can be reproduced by the effect of white due to the tapioca powder and red due to lycopene pigment.

For example, lycopene pigment can be tomato pigment. Lycopene pigment may be added as a mixture with other ingredients. For example, lycopene pigment can be added as a mixture of glycerin, food materials (e.g., water), sucrose fatty acid ester, lecithin and tomato pigment as lycopene pigment.

On the other hand, the feel of the flesh of salmon trout can be reproduced in the seafood imitating product when further adding paprika pigment in addition to lycopene pigment. Paprika pigment can be used with the quantity to reproduce a desired flesh color, and can be added with, for example, per 100 parts by mass of the flesh solution, 0.01 parts by mass or more to 3.0 parts by mass or less, for example, 0.05 parts by mass or more to 0.5 parts by mass or less of the quantity. By containing lycopene pigment and paprika pigment with such a quantity, the color and texture of the flesh of salmon trout can be reproduced by the effect of white due to the tapioca powder, red due to lycopene pigment and orange due to paprika pigment. Furthermore, the feel of the flesh of salmon trout in the seafood imitating product can be reproduced more when adding titanium dioxide to the mixture.

For example, paprika pigment may be red pepper pigment. Paprika pigment may be added as a mixture with other ingredient(s). For example, paprika pigment can be added as a mixture of food materials (e.g., water), mixed tocopherols and red pepper pigment as paprika pigment.

The flesh solution can further include any additives to give the seafood imitating product an objective flavor. Particularly, the taste of the seafood imitating product can be made better by the taste of the vegetable soup by adding vegetable ingredient(s) while imitating the seafood for the mouthfeel. Surprisingly, the inventor(s) of the present invention found that a flavor of the seafood imitating product could be improved by adding vegetable ingredient(s) different from the fish.

Vegetable ingredient(s) may be liquid state and may be granular. In case of liquid state, that is, vegetable soup, it may be those derived from animals such as the bouillon, and may be those which does not include those derived from animals for Vegans.

The vegetable soup can include, for example, water, soy sauce, sugar, salt, fermented seasoning, vegetables (onion, celery, carrot, and the like) and yeast extract, but the ingredients are not particularly limited.

The flesh solution can include other ingredients. The flesh solution also can include, for example, hydroxypropyl starch to increase preservation stability. The flesh solution also can include, for example, potassium chloride as an anticaking ingredient. The anticaking agent is necessary when keeping powder formulation, and is mixed to raw materials. The anticaking agent may be included in raw materials to produce the seafood imitating product of the present invention, and therefore the anticaking agent may be included in the seafood imitating product. Also, glucose and dextrin, and the like can be added to the flesh solution to give the seafood imitating product a feeling of chewy and firmness. Also, the flesh solution can include further ingredients to reproduce a desired color.

### <Mixing of the Flesh Solution>

The flesh solution can be produced by any procedures. Briefly, it can be produced by mixing dietary fiber and the first thickener in water. Also, the flesh solution may be obtained by mixing other ingredients such as tapioca powder and lycopene together.

The container to mix is not particularly limited. For example, mixing and subsequent heating can be performed in the same container by using a pot such as a heat-adjustable electric pot.

When preparing the flesh solution, a mixture may be produced by mixing the first mixture obtained by mixing dietary fiber with thickener and water and the second mixture obtained by mixing tapioca powder with thickener and water.

Also, each ingredient can be mixed at any temperature when preparing the flesh solution. However, materials is not dissolved sufficiently and lumps occur only by mixing materials in water. The temperature to mix can be set at 1° C. or more to 30° 0 or less to prevent the lump of materials from occurring. Alternatively, the mixture may be produced to prevent the lump of materials from occurring while stirring raw materials in water by a high-speed stirrer. Also, when preparing the flesh solution, it is preferable to heat after mixing. It is preferable to perform heating to become the temperature that ingredients of the mixed flesh solution dissolve, for example, at 85° C. or more to 100° C. or less. The color of seafood wanted to imitate can be reproduced closer by performing heating of the flesh solution. Heat mixing is preferable. The temperature of heat mixing is preferably at 60° C. or more, more preferably at 75° C. or more to 100° C. or less.

The flesh solution may be heated to above the melting point of each raw material of dietary fiber, tapioca powder, thickener and colorant(s). When the flesh solution is not heated to above the melting point of each raw material, syneresis occurs when freezing and defrosting the seafood imitating product in the subsequent steps. Therefore, the method for producing the seafood imitating product of the present invention may further comprise heating the flesh solution after preparing the flesh solution.

When adding the colorant(s) different from the tapioca powder, the color does not become as expected when the colorant(s) is mixed after heating. Therefore, when adding the colorant(s) different from the tapioca powder, it is preferable to heat the flesh solution obtained by mixing other materials and colorant(s) together. When heating, it is preferable to heat so that the temperature of the flesh solution is at between 85° C.-100° C. The colorant(s) such as tapioca powder, lycopene pigment and paprika pigment, by heating in the flesh solution, can make coloring better and can reproduce the color of seafood wanted to imitate more.

The flesh solution after heating has viscosity with fluidity. The viscosity of the flesh solution changes depending on the temperature. The higher the temperature is, the lower viscosity the flesh solution has, because each ingredient dissolves by heating. When a solution temperature is, for example, 60° C.-100° C., the viscosity of the flesh solution can be 10 dPa·s-500 dPa·s, for example, 50 dPa·s-200 dPa·s, for example, 60 dPa·s or more to 150 dPa·s. Also, the viscosity of the flesh solution can be 10 dPa·s-500 dPa·s, for example, 50 dPa·s-200 dPa·s, for example, 60 dPa·s-150 dPa·s when the solution temperature is, for example, 70° C.-85° C.

### [Formation of a Layer of the Flesh Solution]

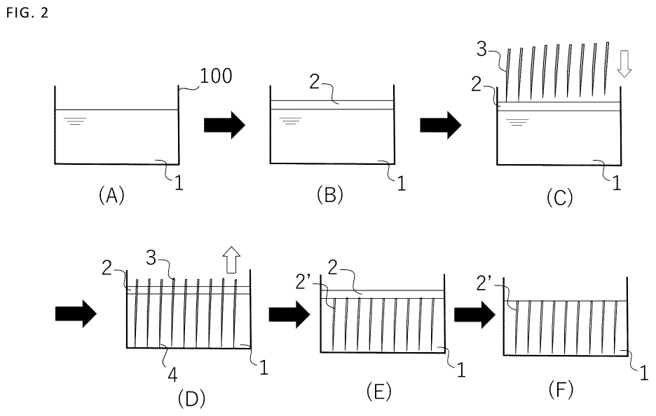

Next, a layer of the flesh solution is formed. The layer of the flesh solution can be formed by any means and can be formed only by, for example, pouring the flesh solution into a container. For example, as shown in FIG. 2(A), layer of the flesh solution 1 can be formed by pouring the flesh solution into mold 100. As described above, as for the flesh solution, the viscosity changes depending on the temperature after heating. Therefore, layer of the flesh solution 1 can be formed easily if it has the viscosity that the flesh solution can be poured into the container. Also, layer of the flesh solution 1 may be formed by heating the flesh solution solidified once in the container again.

### [Preparation of the Tendon Solution]

Separately from the flesh solution, a tendon solution is prepared. The tendon solution can be prepared by mixing titanium dioxide and/or calcium carbonate and the second thickener. For example, it can be prepared by mixing them in water. As used herein, the solution obtained by mixing at least titanium dioxide and/or calcium carbonate and the second thickener in water is referred to as tendon solution. The tendon solution is the material that forms the part imitating fish tendon. The word “fish tendon” includes fish muscle.

As for the tendon solution, titanium dioxide and/or calcium carbonate can be set as, per 100 parts by mass of the tendon solution, 0.2 parts by mass or more to 5 parts by mass or less of the quantity, and it can be preferably set as 0.2 parts by mass or more to 1 part by mass or less of the quantity.

For the second thickener, those given for an example of the first thickener can be used. However, the second thickener is adjusted so that the viscosity of the flesh solution and the viscosity of the tendon solution are different. For example, the quantity of the second thickener is preferably set as, per 100 parts by mass of the tendon solution, 0.05 parts by mass or more to 1 part by mass or less of the quantity, and more preferably 0.1 parts by mass or more to 0.5 parts by mass or less of the quantity. When putting the tendon solution into a cut of the flesh solution by the viscosity of the flesh solution and the viscosity of the tendon solution being different, the flesh solution and the tendon solution are not mixed.

The tendon solution can contain food materials. Also, further any ingredients such as ethanol may be added.

Also, each ingredient can be mixed at any temperature when preparing the tendon solution. However, materials is not dissolved sufficiently and lumps occur only by mixing materials in water. The temperature to mix can be set at 1° C. or more to 30° C. or less to prevent the lump of materials from occurring. Alternatively, mixtures may be produced to prevent the lump of materials from occurring while stirring raw materials in water by a high-speed stirrer. Also, it is preferable to heat after mixing when preparing the tendon solution. It is preferable to perform heating to become the temperature that ingredients of the mixed tendon solution dissolve, for example, the temperature of 85° C. or more to 100° C. or less. The color of seafood wanted to imitate can be reproduced closer by performing heating of the tendon solution. Heat mixing is preferable. The temperature of heat mixing is preferably at 60° C. or more, and more preferably at 75° C. or more to 100° C. or less.

The tendon solution is adjusted to have the viscosity different from the flesh solution. The flesh solution and the tendon solution are solution having different viscosity each other by adjusting ingredients of the first thickener and ingredients of the second thickener appropriately. Also, the viscosity of the tendon solution is lower than that of the flesh solution. The tendon solution is formulated so that it does not mix with the flesh solution. Therefore, the tendon solution is formulated to become the layer of the tendon not to be mixed with the flesh solution, when a cut is made in the layer of the flesh solution and the tendon solution is put into the flesh solution. On the other hand, in the method for producing the seafood imitating product of the present invention, the lower viscosity the tendon solution has, the easier the tendon solution gets into the inside of the flesh solution. Therefore, the viscosity of the tendon solution is preferably low enough so that the tendon solution gets into within the flesh solution without mixing with the flesh solution, and also so that the tendon solution easily gets into within the flesh solution.

The tendon solution after heating has the viscosity with fluidity. The viscosity of the tendon solution changes depending on the temperature. Since each ingredient dissolves by heating, the viscosity of the tendon solution decreases as the temperature increases. When solution temperature is, for example, at 60° C.-100° C., the viscosity of the tendon solution can be 0.01 dPa·s-10 dPa·s, for example, 0.1 dPa·s-0.6 dPa·s. Also, the viscosity of the flesh solution can be 0.01 dPa·s-10 dPa·s, for example, 0.1 dPa·s-0.6 dPa·s, when solution temperature is, for example, at 70° C.-85° C.

### [Formation of a Layer of the Tendon Solution]

Next, using the tendon solution, a layer of tendon solution 2 is formed on a layer of flesh solution 1 as shown in FIG. 2(B). Because viscosities of flesh solution 1 and tendon solution 2 are different from each other, the layer of flesh solution 1 and the layer of tendon solution 2 are not mixed.

The thickness can be set as any thickness to the thickness of the layer of flesh solution 1. For example, the thickness of the layer of tendon solution 2 can be 0.5 mm or more to 30 mm or less. The thicker the layer of tendon solution 2 is, the more quantity of tendon in the imitation food can be increased, and the thinner the layer of tendon solution 2 is, the more quantity of the tendon in the imitation food can be decreased.

When forming the layer of tendon solution 2 on the layer of flesh solution 1, as for the temperature of flesh solution 1 and tendon solution 2, the temperature of both are adjusted to have the viscosity that the tendon solution can get into within the flesh solution. The temperature of flesh solution 1 and tendon solution 2 can be at, for example, 60° C. or more to 100° C. or less, for example, 65° C. or more to 90° C. or less, for example, 70° C. or more to 85° C. or less. Also, it is preferable for flesh solution 1 and tendon solution 2 not to be less than the temperature described above before forming the layer of tendon solution 2 on the layer of flesh solution 1, that is, to have the temperature of 60° C. or more, for example, 65° C. or more, for example, 75° C. or more, after heating at the time of preparation of each solution. When temperature falls once, fluidity of flesh solution 1 and tendon solution 2 decrease, and second heating is necessary.

### [Making a Cut]

Next, as shown in FIG. 2(C), inserting blade 3 from the above of the layer of tendon solution 2, making a cut (4 of FIG. 2(D)) in the layer of flesh solution 1 through layer of the tendon solution 2 by blade 3.

The shape of blade 3 can be selected to adapt to the shape of the tendon formed in the imitation food appropriately. The thickness of blade 3 can be selected depending on the thickness of the tendon. Blade 3 can be a blade of, for example the thickness of 0.1 mm-10 mm, for example, the thickness of 1 mm-5 mm, for example, a stainless plate. Also, by arranging a plurality of blade 3 as shown in FIG. 2, it is possible to make cuts in the flesh solution at a time and put the tendon solution into.

[putting the tendon solution into a cut]

Next, blade 3 is pulled up in the direction of the open arrow in FIG. 2(D) from the layer of flesh solution 1. Tendon liquid 2 gets into cut 4 provided in the layer of flesh solution 1 as shown in FIG. 2(E) without mixing with flesh solution 1 and tendon solution 2 when blade 3 is pulled up because flesh solution 1 and tendon solution 2 have different viscosity. At this time, the viscosity of flesh solution 1 and tendon solution 2 is the viscosity that the tendon solution can flow into in the flesh solution. For example, in case of the flesh solution and the tendon solution shown in the following examples, the viscosity of flesh solution 1 and tendon solution 2 is the viscosity that the tendon solution can flow into the flesh solution if the temperature is at 70° C. or more, for example, 80° C. or more.

Note that a plurality of cut 4 is formed in FIG. 2 at the same time, however cut 4 may be formed one by one, and tendon solution 2 may be put one by one into cut 4 formed one by one.

### <Solidification>

Next, flesh solution 1 and tendon solution 2 are solidified. Herein, to solidify includes to solidify the liquid flesh solution to the condition where it is not liquid and does not have fluidity, and, for example, includes to form a solidified gelatinous gel.

The solidification can be performed by solidifying flesh solution 1 and tendon solution 2 by the method that depends on ingredients of flesh solution 1 and tendon solution 2, for example, by increasing viscosity of flesh solution 1 and tendon solution 2 and removing fluidity.

Flesh solution 1 and tendon solution 2 can be solidified, for example, by cooling. Flesh solution 1 and tendon solution 2 can be solidified, for example, by cooling flesh solution 1 and tendon solution 2 at 20° C. or less using the rapid coolers such as blast chillers by the air blast. Also, flesh solution 1 and tendon solution 2 can be solidified by cooling to 0° C.-4° C. rapidly. However, it is preferable to rapidly cool and solidify to raise safety, quality and efficiency at the time of cooling. Alternatively, as for flesh solution 1 and tendon solution 2, when using, for example, glucomannan as dietary fiber, edible calcium hydroxide called the lye is added to flesh solution 1, and solidification (coagulation) of flesh solution 1 can be performed by mixing.

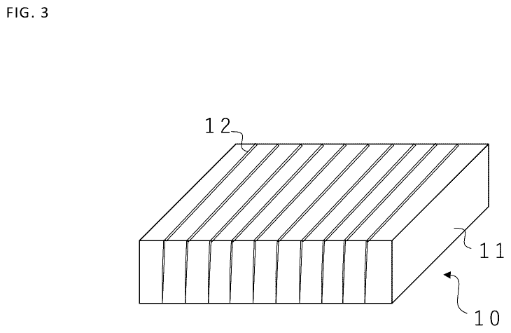

After solidifying flesh solution 1 and tendon solution 2, only tendon solution 2 put into flesh solution 1 may be left as shown in FIG. 2(F) by shaving off the layer of tendon solution 2 on flesh solution 1 which is solidified. The seafood imitating product 10 which the tendon is formed only within the flesh as shown in FIG. 3 can be obtained by shaving off the layer of tendon solution 2 as shown in FIG. 2(F). The seafood imitating product 10 is formed integrally with the flesh 11 and the tendon 12, which is formed within the flesh 11, closely adhered together. Such seafood imitating product 10 has the appearance that tendon 12 gets into flesh 11, just like real seafood. Also, it does not come off between flesh 11 and tendon 12 and the imitation food which is superior mouthfeel and appearance can be produced by flesh 11 and tendon 12 adhering.

### <Freezing>

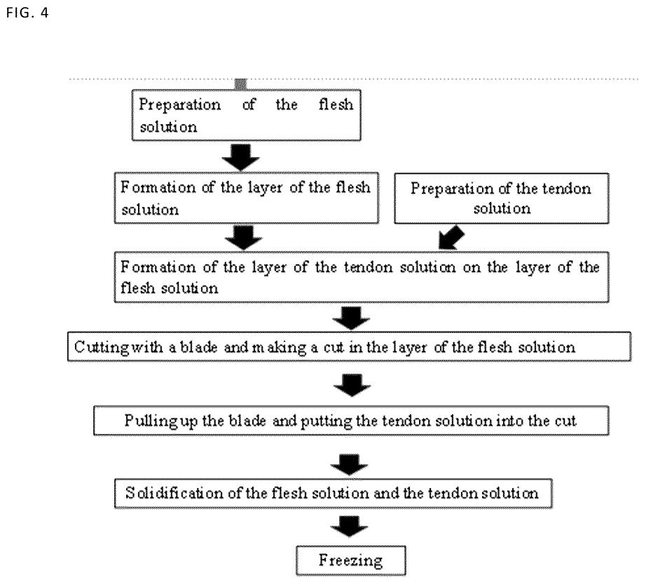

When the flesh solution 1 contains the tapioca powder, as shown in FIG. 4, it is preferable to freeze the seafood imitating product. Then, a solidified body is frozen. The temperature of freezing can be performed at, but is not particularly limited to, for example, 0° C. or less, and the temperature of −18° C. or less, for example, can be cooled at −20° C.-−40° C. As for the means of freezing, it is preferable to, but is not particularly limited to, quick freeze. The freezing can be quick freezing, for example, by a blast chiller by the air blast or a brine. Also, the steps of cooling and freezing may be carried out by cooling in succession, and it may be frozen at 0° C. or less directly.

The inventors of the present invention found that the cloudiness just like the seafood could be given to the solidified body by freezing the solidified body obtained by solidifying the flesh solution described above including tapioca. Also, it becomes easy to cut the imitation food by freezing. If the cloudiness, which the seafood imitating product of the present invention has, is not provided to the solidified body, transparency of the imitation food becomes higher too much, and it becomes to the gelatinous feel food which cannot be seen as the seafood.

The solidified body before freezing has feel with a little cloudiness or no cloudiness. Therefore the cloudiness of the flesh peculiar to the seafood cannot be reproduced enough. On the other hand, the seafood imitating product after freezing presents just like the cloudiness peculiar to the seafood.

That is, according to the seafood imitating product of the present invention, the cloudiness of the flesh peculiar to the seafood can be reproduced. Besides, the mouthfeel of the seafood can also be reproduced. Furthermore, the red fleshes such as tuna or salmon can be reproduced when mixing the colorant different from tapioca, for example, lycopene pigment and paprika pigment, and using the heated flesh solution. The flesh solution may contain various ingredients, and ingredients which increase flavors can be put.

After freezing, defrosting may be performed to produce the seafood imitating product. Alternatively, a frozen state may be assumed a finished product without defrosting.

### Example 1

The seafood imitating product imitating tuna was produced.

### [Preparation of the Flesh Solution]

At first, the raw materials of ingredients showing in Table 1 was prepared to produce the seafood imitating product imitating tuna. In Table 1, the composition amount is shown in kg, and the composition ratio in the final flesh solution is shown as % by weight.

TABLE 1

| | composition amount | composition ratio |
|---|---|---|
| | (kg) | (% by weight) |
| raw materials 1 | | |
| clean water | 66 | 76.48% |
| lycopene(soy) | 0.15 | 0.17% |
| dextrin | 4 | 4.63% |
| mannan | 0.711 | 0.82% |
| carrageenan | 0.594 | 0.69% |
| locust bean gum | 0.24 | 0.28% |
| guar gum | 0.156 | 0.18% |
| gellan gum | 0.036 | 0.04% |
| xanthan gum | 0.012 | 0.01% |
| potassium chloride | 0.201 | 0.23% |
| glucose | 0.987 | 1.14% |
| agar | 0.063 | 0.07% |
| salt | 0.15 | 0.17% |
| raw materials 2 | | |
| clean water | 4 | 4.63% |
| cornstarch | 2.4 | 2.78% |
| tapioca starch | 1.6 | 1.85% |
| raw materials 3 | | |
| vegetable soup | 5 | 5.79% |
| total | 86.3 | 100.00% |

Ingredients shown in raw materials 1 were entered into the pot of, outside size: 1,850 mm in width, 1,090 mm in depth, 1,160 mm in height, inside diameter of inner pot: 1,000 mm, depth of inner pot: 560 mm, quantity of full water: approximately 380 liters and mixed with a stirrer. The temperature was controlled at 30° C. or less.

On the other hand, the solution of cornstarch and tapioca starch shown in raw materials 2 was prepared. 2.4 kg of cornstarch (2.78% by weight in the final flesh solution) and 1.6 kg of tapioca starch (1.85% by weight in the final flesh solution) were put into 4 kg of water (4.63% by weight in the final flesh solution) and mixed. The mixing was performed at 30° C. or less. The prepared cornstarch and tapioca solution of raw materials 2 were put into the mixture of raw materials 1 described above.

The vegetable soup of raw materials 3 has composition showing in Table 2.

TABLE 2

| | |
|---|---|
| water | 43.71% |
| soy sauce | 12.24% |
| sugar | 11.02% |
| salt | 10.04% |
| onion | 8.74% |
| fermentated seasoning | 4.90% |
| celery | 4.37% |
| carrot | 4.37% |
| yeast extract | 0.61% |

Next, heating of contents of the pot was started. During heating, 5 kg of vegetable soup (5.79% by weight of the final flesh solution) was put into the pot containing raw materials 1 and raw materials 2.

Heating was stopped at the point when the contents of the pot exceeded 85° C. Thereby, the flesh solution was obtained.

The viscosity of the flesh solution of this time was measured. The viscosity was measured according to the procedure using VISCOMETER VT-06, RION CO., LTD. The viscosity was 70 dPa·s-80 dPa·s when the temperature of the flesh solution was at 80° C.-85° C.

Also, Brix level of the flesh solution was measured at the point when the temperature of the center core was at 85° C. by a Brix scale as the viscosity of the solution. The density of the flesh solution was 15%-18%. Note that, herein, “Brix level” is the physical quantity used as a sugar content to measure content of the sugar. When measuring 100 g of water solution including only 1 g of sucrose as a solute by Brix refractometer, the Brix level which is its indication is 1%. For example, as for the solution which 10 g of sucrose dissolve in 100 g of solution (90 g of water), a Brix level becomes 10%. For example, the flesh solution can be 1%-40%, 12%-20% or 15%-18% of Brix levels.

### [Preparation of the Tendon Solution]

The following raw materials were prepared.

TABLE 3

| | composition amount | composition ratio |
|---|---|---|
| raw materials | (kg) | (% by weight) |
| clean water | 7.7 | 93.09% |
| titanium dioxide | 0.44 | 5.32% |
| agar | 0.132 | 1.60% |
| total | 7.7 | 93.09% |

These raw materials were mixed to prepare the tendon solution.

The viscosity of the tendon solution of this time was measured. The viscosity was measured according to the procedure using VISCOMETER VT-06, RION CO., LTD. When the temperature of the tendon solution was at 80° C.-85° C., the viscosity was 0.3 dPa·s-0.6 dPa·s, and it was the solution close to water which has low viscosity.

### [Formation of the Layer of the Flesh Solution and Formation of the Layer of the Tendon Solution]

The flesh solution at 80° C.-85° C. was put in a mold, and the layer of the flesh solution was formed. Then, on the layer of the flesh solution, the tendon solution at 80° C.-85° C. was poured, and the layer of the tendon solution was formed. To the thickness of the layer of flesh solution 1, the thickness of the layer of tendon solution 2 was set as 30 mm.

### [Formation of a Cut]

Next, inserting a blade of a stainless plate of 5 mm from the above of the layer of the tendon solution, and a cut was made in the layer of the flesh solution by the blade through the layer of the tendon solution. After that, the blade was pulled up. Thereby, the tendon solution got into the cut of the layer of the flesh solution.

### [Solidification]

In this state, the flesh solution and the tendon solution were solidified, respectively. The flesh solution and the tendon solution were solidified by cooling the container at 0° C.-4° C. with a blast chiller, and a solidified body was obtained.

### [Freezing]

The solidified body was rapidly cooled in a freezer at −40° C., and the solidified body of the flesh solution and the tendon solution was frozen. The layer of the tendon solution which did not get into the layer of the flesh solution was shaved off from the frozen solidified body.

### [Defrosting]

The frozen solidified body was bagged, and the bag was sealed. The bag was put in warm water at 50° C. or less, and was left for 0.5 hours. Thereby, defrosting was performed, and the seafood imitating product of Example 1 was obtained.

### [Evaluation]

The sensory test of the seafood imitating product produced by the method described above was performed. The evaluation was performed with the following procedures.

### 1. Carrying Out of the Sensory Test Procedure

The panelists carrying out the sensory test are people who have the experience of the inspection step of the product and can judge a flesh color of tuna, a rotting smell and an off-odor. In addition, the panelists carrying out the sensory test who were passed a discrimination test of taste were picked.

As for the panelist, five panelists for bacteria testing operator, tuna workpiece and the seafood imitating product were picked. The sensory test was carried out under the following conditions.
The sensory test is performed at the time when the panelists are neither hungry nor full.
The test sample is inspected at the temperature when it is usually eaten.
The quantity of the test sample that the panelists can feel hardness to chew and feeling on the tongue is prepared.
The panelists who performed the sensory test judge colors, smells and tastes, and record a result.
The panelists who performed the sensory test judge including mouthfeel and syneresis, and record a result.
Before the test and while eating each product, the influence on the test for next product is suppressed by, for example, drinking water.

The judgment of the propriety in the sensory test was carried out about four items of the following color, smell, mouthfeel and syneresis. The criterion of each item as follows.
Color: compared to tuna, salmon and squid, to have the color that is similar or close to.
Smell: not to have a rotting smell or an off-odor.
Mouthfeel: to have the mouthfeel that is close to tuna, salmon and squid and taste peculiar to the imitation food.
Syneresis: obvious syneresis does not occur at the time of defrosting.

### 2. Sensory Test Result

By the procedure described above, the seafood imitating product was produced ten times, and the test was carried out. About all of ten times of the seafood imitating product, all of five panelists judged all of items of color, smell, mouthfeel and syneresis to be qualified.

Also, the seafood imitating product produced by the method described above did not come off in the tendon parts because the tendon parts and the parts of the flesh were united. Also, the seafood imitating product produced by the method described above had a sashimi-like mouthfeel. Also, the seafood imitating product produced by the method described above had a red flesh-like appearance of tuna by coloring of white due to tapioca starch and red due to lycopene.

### Example 2

The seafood imitating product imitating salmon was produced.

### [Preparation of the Flesh Solution]

At first, to produce the seafood imitating product imitating salmon, the raw materials of ingredients showing in Table 2 were prepared. In Table 2, the composition amount is shown in kg, and the composition ratio in the final flesh solution is shown as % by weight.

TABLE 4

| | composition amount | composition ratio |
|---|---|---|
| | (kg) | (% by weight) |
| raw materials 1 | | |
| clean water | 66 | 76.41% |
| lycopene(soy) | 0.032 | 0.04% |
| paprika pigment | 0.16 | 0.19% |
| titanium dioxide | 0.032 | 0.04% |
| dextrin | 4 | 4.63% |
| mannan | 0.711 | 0.82% |
| carrageenan | 0.594 | 0.69% |
| locust bean gum | 0.24 | 0.28% |
| guar gum | 0.156 | 0.18% |
| gellan gum | 0.036 | 0.04% |
| xanthan gum | 0.012 | 0.01% |
| potassium chloride | 0.201 | 0.23% |
| glucose | 0.987 | 1.14% |
| agar | 0.063 | 0.07% |
| salt | 0.15 | 0.17% |
| raw materials 2 | | |
| clean water | 4 | 4.63% |
| cornstarch | 2.4 | 2.78% |
| tapioca starch | 1.6 | 1.85% |
| raw materials 3 | | |
| vegetable soup | 5 | 5.79% |
| total | 86.374 | 100.00% |

Ingredients shown in raw materials 1 were entered in the pot of outside size: 1,850 mm in width, 1,090 mm in depth, 1,160 mm in height, inside diameter of inner pot: 1,000 mm, depth of inner pot: 560 mm, quantity of full water: approximately 380 liters similar to the one used in Example 1 and mixed with a stirrer. The temperature was controlled at 30° C. or less.

On the other hand, the solution of cornstarch and tapioca starch shown in raw materials 2 was prepared. 2.4 kg of cornstarch (2.78% by weight in the final flesh solution) and 1.6 kg of tapioca starch (1.85% by weight in the final flesh solution) were put into 4 kg of water (4.63% by weight in the final flesh solution), and mixed. The mixing was performed at 30° C. or less. The prepared raw materials 2, the solution of cornstarch and tapioca, was put into the mixture of raw materials 1 described above.

The vegetable soup of raw materials 3 has composition showing in Table 2 described above.

Next, heating of the contents of the pot was started as Example 1. During heating, 5 kg of vegetable soup (5.79% by weight of the final flesh solution) was put into the pot containing raw materials 1 and raw materials 2.

Heating was stopped at the point when the contents of the pot exceeded 85° C. Thereby, the flesh solution was obtained.

The viscosity of the flesh solution of this time was measured. The viscosity was measured according to the procedure using VISCOMETER VT-06, RION CO., LTD. The viscosity was 70 dPa·s-80 dPa·s when the temperature of the flesh solution was at 80° C.-85° C.

Also, the Brix level of the flesh solution was measured at the time when the temperature of the center core was at 85° C. by a Brix scale a, the viscosity of the solution. The density of the flesh solution was 15%-18%.

[preparation of the tendon solution]

The tendon solution was prepared with the procedure same as Example 1.

[formation of the layer of the flesh solution and formation of the layer of the tendon solution]

A layer of the flesh solution and a layer of the tendon solution were formed with the procedure same as Example 1.

### [Formation of a Cut]

A cut was formed with the procedure same as Example 1, and the tendon solution got into the cut of the layer of the flesh solution.

### [Solidification]

A solidified body was obtained with the procedure same as Example 1.

### [Freezing]

A solidified body was frozen, and the layer of the tendon solution which did not get into the layer of the flesh solution was shaved off from the frozen solidified body with the procedure same as Example 1.

### [Evaluation]

As Example 1, the seafood imitating product of Example 2 was evaluated.

### Sensory Test Result

By the procedure described above, the seafood imitating product was produced ten times, and the test was carried out. About all of ten times of the seafood imitating product, all of five panelists judged all of items of color, smell, mouthfeel and syneresis to be qualified.

Also, the seafood imitating product produced by the method described above did not come off in the tendon parts because the tendon parts and the parts of the flesh were united. Also, the seafood imitating product produced by the method described above had a sashimi-like mouthfeel. Also, the seafood imitating product produced by the method described above had a red flesh-like appearance of salmon by coloring with white due to tapioca starch and red due to paprika pigment and lycopene.

### INDUSTRIAL APPLICABILITY

The method for producing the seafood imitating product of the present invention described above can produce the seafood imitating product with the tendon just like the real seafood by forming the layer of the tendon solution having the different viscosity from the flesh solution to the layer of flesh solution, and making a cut in the layer of the flesh solution by a blade through this layer of the tendon solution, and putting the tendon solution in the cut by pulling up a blade.

Also, color, cloudiness and mouthfeel of the red flesh of tuna and salmon can be also reproduced by solidifying and freezing the flesh solution containing tapioca powder, paprika pigment and lycopene pigment, and the like.

### REFERENCE SIGNS LIST

1 . . . flesh solution,
2 . . . tendon solution,
3 . . . blade,
4 . . . cut,
10 . . . seafood imitating product,
11 . . . flesh,
12 . . . tendon.
   All patent and non patent literature disclosed herein is incorporated by reference herein.

1. A method for producing a seafood imitating product including dietary fiber, comprising:
mixing dietary fiber and the first thickener in water to prepare a flesh solution;
forming a layer of the flesh solution;
preparing a tendon solution which includes titanium dioxide and/or calcium carbonate and the second thickener and has different viscosity from the flesh solution;
forming a layer of the tendon solution on the layer of the flesh solution;
inserting a blade from the above of the layer of the tendon solution and making a cut in the layer of the flesh solution by the blade through the layer of the tendon solution;
pulling up the blade and putting the tendon solution into the cut of the layer of the flesh solution; and
solidifying the flesh solution and the tendon solution.

2. The method for producing the seafood imitating product according to claim 1, wherein the flesh solution is prepared by further mixing with tapioca powder and/or lycopene.

3. The method for producing the seafood imitating product according to claim 2, further comprising freezing the solidified body after solidifying the flesh solution and the tendon solution.

4. The method for producing the seafood imitating product according to claim 1, wherein the flesh solution is prepared by further mixing with vegetable soup.

5. The method for producing the seafood imitating product according to claim 2, wherein the flesh solution is prepared by further mixing with vegetable soup.

6. The method for producing the seafood imitating product according to claim 3, wherein the flesh solution is prepared by further mixing with vegetable soup.
